(19) United States
(12) Patent Application Publication
(10) Pub. No.: US 2016/0224003 A1
(43) Pub. Date: Aug. 4, 2016

(54) REPLACEMENT OF A FAULTY SYSTEM COMPONENT IN AN AUTOMATION SYSTEM

(71) Applicant: SIEMENS AKTIENGESELLSCHAFT, 80333 Munchen (DE)

(72) Inventors: FRANK BUSCHMANN, Munchen (DE); JÖRG NEIDIG, Nurnberg (DE)

(73) Assignee: SIEMENS AKTIENGESELLSCHAFT, 80333 Munchen (DE)

(21) Appl. No.: 15/012,517

(22) Filed: Feb. 1, 2016

(30) Foreign Application Priority Data
Feb. 2, 2015 (EP) 15153469.0

(51) Int. Cl. G05B 19/05; G05B 23/02

(52) U.S. Cl. CPC G05B 19/058; G05B 23/0243; G05B 2219/24072

(57) ABSTRACT

A method for replacing a faulty system component in an automation system includes the steps of providing for an operating location of the system component a location description having an operating condition that needs to be satisfied at the operating location; providing for a possible substitute component a component description with operating states that can be assumed by the substitute component and that are described independent of a technical design of the substitute component; determining the component description for which the operating states that can be assumed satisfy each operating condition contained in the location description; selecting the substitute component associated with the determined component description; and indicating the selected substitute component for installation at the operating location.

### CROSS-REFERENCES TO RELATED APPLICATIONS

This application claims the priority of European Patent Application, Serial No. EP 15153469.0, filed Feb. 2, 2015, pursuant to 35 U.S.C. 119(a)-(d), the content of which is incorporated herein by reference in its entirety as if fully set forth herein.

### BACKGROUND OF THE INVENTION

The present invention relates to a method for replacing a faulty system component in an automation system. The invention also includes a control device that is designed to carry out the method and an automation system that includes the control device according to the invention.

The following discussion of related art is provided to assist the reader in understanding the advantages of the invention, and is not to be construed as an admission that this related art is prior art to this invention.

An automation system can have modules or system components that interact in the automation system in order to carry out a predetermined process. By way of example, the automation system may be a production system in which a product, for example a motor vehicle, is produced. The automation system may also be a process system in which a process is performed, for example generating electric power from nuclear power. The automation system may also be a control system that controls equipment in coordinated fashion, for example traffic lights in a transport network.

If one of the system components is faulty and therefore no longer functional, the remainder of the system components is no longer able to perform the process owing to the interrupted process chain. In order to keep a downtime for the automation system as short as possible, a substitute component needs to be found for the faulty system component, and this substitute component needs to be readied for operation in the system, that is to say parameterized or programmed, for example, as quickly as possible. Particularly in the case of older systems, it may be that an equipment type or equipment model of the faulty system component can be acquired only at great expense or is no longer available in the first place. If it is then necessary to install a substitute component in the automation system that is based on a different equipment model, it is normally also necessary to adapt the remainder of the system components so that the substitute component can actually interact with the remainder of the system components. In the worst case, redesign of the engineering may even be required, that is to say that, on the basis of the new substitute component, the respective tasks that are accomplished by each of the system components need to be redistributed and accordingly new control programs, for example for programmable logic controllers (PLCs) of the individual system components, need to be produced and stored in the system components.

It would therefore be desirable and advantageous to obviate prior art shortcomings and to provide an improved automation system that becomes operational again at little expense in the event of a fault in a system component.

### SUMMARY OF THE INVENTION

According to one aspect of the present invention, a method for replacing a faulty system component in an automation system includes the following steps, which are performed by a controller of the automation system: providing for an operating location of the system component a location description having an operating condition that needs to be satisfied at the operating location; providing for a possible substitute component a component description with operating states that can be assumed by the substitute component and that are described independent of a technical design of the substitute component; determining the component description for which the operating states that can be assumed satisfy each operating condition contained in the location description; selecting the substitute component associated with the determined component description; and indicating the selected substitute component for installation at the operating location.

By way of example, a location description for an operating location at which a conveyor belt is positioned can involve, as an operating condition, an individually packaged good or a product needing to be transported from a position A, that is to say the start of the conveyor belt, to a position B, that is to say the end of the conveyor belt.

If a system component is faulty, then a possible substitute component or a plurality of possible substitute components is considered as a replacement component for the faulty system component. For at least one such possible substitute component, a respective component description is provided. The component description contains operating states that can be adopted by the respective substitute component. An essential feature in this case is that the operating states are described independently of the technical design of the substitute component. By way of example, a component description can state that a product can be accepted at position A and the product can be conveyed to a position B. The component description does not indicate in this case whether the associated substitute component is likewise a conveyor belt or, for example, a robot that lifts the product from A to B by means of a robot arm.

The method additionally provides for that component description for which the adoptable operating states satisfy each operating condition that the location description contains to be determined. In other words, the control device checks whether there is a substitute component that is capable of fulfilling every operating condition by adopting appropriate operating states. This substitute component is then thus a complete substitute for the faulty system component.

Accordingly, a further step is used to indicate that the selected substitute component is suitable for installation at the operating location. In other words, it is used to indicate that the selected substitute component can be installed at the operating location.

The invention results in the advantage that, if a system component fails, for example when a faulty system component needs to be replaced, a control device can, in automated fashion, that is to say without any action by a user of the automation system, determine a suitable substitute component that does not need to be of the same equipment model or component type as the faulty system component, so long as it can adopt all the necessary operating states that can satisfy the operating conditions at the operating location. By way of example, it is thus possible for a conveyor belt to be replaced by a robot, so long as the robot can perform all the necessary transport movements.

The invention also relates to a control device with a processor configured to execute the aforedescribed method. By way of example, the processor can include one or more digital processors. By way of example, the control device may be a central computation apparatus of the automation system or a programmable logic controller of a system component, for example a system component arranged next to the operating location.

Finally, the invention also includes relates to an automation system that includes the control device according to the invention. The automation system may be a production system or a process system or a control system.

According to an advantageous feature of the present invention, the location description of the operating location may have the at least one operating condition respectively defined independently of how the operating condition is satisfied. In other words, the location description dispenses particularly with a representation of the internal dynamic processes at the operating location. This results in the advantage that the location description does not result in any restriction for the selection of suitable or possible substitute components. By way of example, the location description dispenses with mentioning a conveyor belt, which means that a robot with a gripper arm can also satisfy the at least one operating condition to be satisfied.

According to another advantageous feature of the present invention, the location description may contain at least one input condition as an operating condition. Each input condition describes a respective operating state that the system requires for the substitute component, which operating state is intended to be present at the beginning of a process step that needs to be performed at the operating location. By way of example, it may contain a position statement that indicates where a product is intended to be accepted or received by the substitute component. Additionally or alternatively, the input condition may describe an initial state of a product that needs to be handled at the operating location. In other words, it indicates the production state or product state from which the substitute component is intended to be able to start. By way of example, in the case of a bottling plant, there may be a stipulation that the substitute component is intended to be able to receive empty bottles that are, however, already cleaned. Additionally or alternatively, the input condition may define an operating state of a system component that assists the operating location. By way of example, it may indicate that a product emerges from the assisting system component, and needs to be received at the operating location, at a particular conveying speed. By taking account of the input condition, the selected substitute component can advantageously be reliably coupled to the automation system even without modifying the remainder of the automation system.

According to another advantageous feature of the present invention, the location description may contain at least one output condition as a respective operating condition. Each output condition may describe a final state that the system needs for the substitute component at the operating location. In this context, final state means particularly that, following completion of a work step that needs to be repeated cyclically, the substitute component needs to be in the final state. By way of example, this may be a robot arm final position that is needed so that the transported individually packaged good or the transported product can be received by a downstream system component. Additionally or alternatively, the output condition may define a final state of a product that needs to be handled at the operating location. In other words, it stipulates what production step the substitute component needs to perform on the product. Additionally or alternatively, an operating state of a system component downstream of the operating location may be defined. In other words, there is a stipulation of what operating state of the downstream component the substitute component needs to be able to deal with or be compatible with. In this way, the outputs produced by the substitute component when performing its associated process steps may advantageously be output to the remainder of the automation system without any problems and/or successfully.

According to another advantageous feature of the present invention, each component description may contain at least one operating environment condition that is needed by the substitute component, i.e. constraints that are necessary for the operation of the substitute component. The control device selects that substitute component whose at least one operating environment condition is satisfied by the operating location. By way of example, an operating environment condition may be that a particular air flow for cooling the substitute component is intended to be able to be drawn in from the environment and conveyed to the environment again. If the operating location is in the open, so that this cooling air flow can be conveyed, then this substitute component is suitable for being operated at the operating location. If, by contrast, the operating location is of particularly narrow design, for example, then it is only possible to choose a substitute component that needs a smaller air flow or no air cooling. Taking account of the operating environment condition results in the advantage that the selected substitute component can be started up directly at the operating location without further adaptation of the remainder of the automation system.

According to another advantageous feature of the present invention, each component description may include an interface definition for an electronic interface of the substitute component. The interface definition describes a parameter that can be transmitted via the interface. In other words, it describes what value can be transmitted either from the substitute component to a downstream system component or from an upstream system component to the substitute component. By way of example, it can thus indicate that the interface is used to transmit a temperature value or a speed value. Additionally or alternatively, a signal format of a signal may be described by the interface definition. By way of example, it can indicate that a signal value of for example 3 volts corresponds to a temperature of for example 20 degrees. The control device compares a compatibility of a system-side connection interface with the interface of the substitute component. In other words, it checks whether the parameters and/or signals provided in the system at the electronic connection interface match the parameters and/or signals provided at the interface of the substitute component. This results in the advantage that the control device checks whether control and/or monitoring of the substitute component with the previous system programming or system configuration is possible or can be performed. A substitute component can then advantageously be determined that indicates that reconfiguration or reprogramming of the automation system is unnecessary or can be dispensed with.

in this connection, according to another advantageous feature of the present invention, if a substitute component with such compatibility cannot be determined, then the following method step is performed. A signal conversion is produced that converts the signal from the interface and a signal from the system-side connection interface into one another. In other words, both the automation system and the substitute component can continue to be operated without reconfiguration, that is to say in unaltered fashion. At the signal transition between the connection interface of the automation system and the interface of the substitute component, the signal conversion compensates for the incompatibility between the signals. By way of example, the signal conversion may be implemented by a program module that is executed by the substitute component and/or an upstream or downstream system component. A conversion table may additionally or alternatively be provided.

According to another advantageous feature of the present invention, each component description may be provided as a digital model of the substitute component, and the model simulates a behavior of the substitute component on a physical interface and/or an electronic control interface of the substitute component. In other words, the model describes the substitute component externally or in other words as a black box or simply with an outer perspective. Substitute components can then advantageously be represented independently of their technical embodiment, for example as a conveyor belt or as a robot with a robot arm, and their suitability for operation at the operating location can be checked, e.g. in a simulation.

According to another advantageous feature of the present invention, each component description may also contain physical properties of the respective substitute component. In particular, the respective physical properties may be geometrical dimensions and/or installation space geometries and/or connection geometries of connections of the substitute component. The control device compares the physical properties with corresponding physical situations at the operating location. Thus, a check is performed to determine whether a geometrical dimension or installation space geometry of the substitute component matches the available installation space or room at the operating location. Likewise, connection geometries of supply connections or supply lines can be compared with the connection geometries of the substitute component. When a difference between the properties and the corresponding situations at the operating location is detected, the associated substitute component is excluded from the selection. This results in the advantage that determination of the substitute component by the control device does not involve determination of a substitute component that would be impossible to install in the automation system. This automates a further checking step or plausibilization step that would otherwise need to be performed by a user of the automation system.

According to another advantageous feature of the present invention, each component description may indicate a resource of the substitute component that needs to be provided at the operating location by the automation system. The control device excludes the associated substitute component from the selection if the resource is absent. By way of example, the resource indicated may be a required flow of energy, that is to say e.g. a minimum value for e.g. electric power or heating power or cooling power. Provision may also be made for the resource required to be a compressed air connection or a water connection, for example. If a resource is absent, then operation of the substitute component at the operating location is impossible or the automation system needs to be at least upgraded. As a result of exclusion of the substitute component, the control device thus selects only such substitute components as can be operated with the available resources.

As already explained, the control device can be provided by a central processor of the automation system, i.e. for example by a processor of a control station or of an engineering system of the automation system. Alternatively, the control device may be provided by a system component that is for example disposed proximate to the operating location. This is advantageous particularly in the case of local control of the automation system.

According to another advantageous feature of the present invention, the selected substitute component may also be configured for operation at the operating location on the basis of the location description. In other words, the substitute component may be configured or programmed by the control device, i.e. autonomously or automatically. This results in the advantage that an operating behavior by the substitute component for operation that is required at the operating location for performing the task at the operating location is prepared without this requiring a user to program the substitute component.

According to another advantageous feature of the present invention, in an engineering plan that determines operation of the automation system, the engineering data for the faulty system component are replaced by engineering data for the selected substitute component. Engineering data are a description of the technical properties of the respective component. This results in the advantage that the engineering plan, that is to say the technical plan of the system, is also automatically adapted to the new system configuration. By way of example, the engineering plan may include the control programs for the programmable logic controllers of all system components. By way of example, the engineering plan may also describe the geometrical arrangement of the system components, for example in an industrial warehouse or on company premises.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic illustration of an embodiment of the automation system according to the present invention, and

FIG. 2 shows a flowchart for an embodiment of the method according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

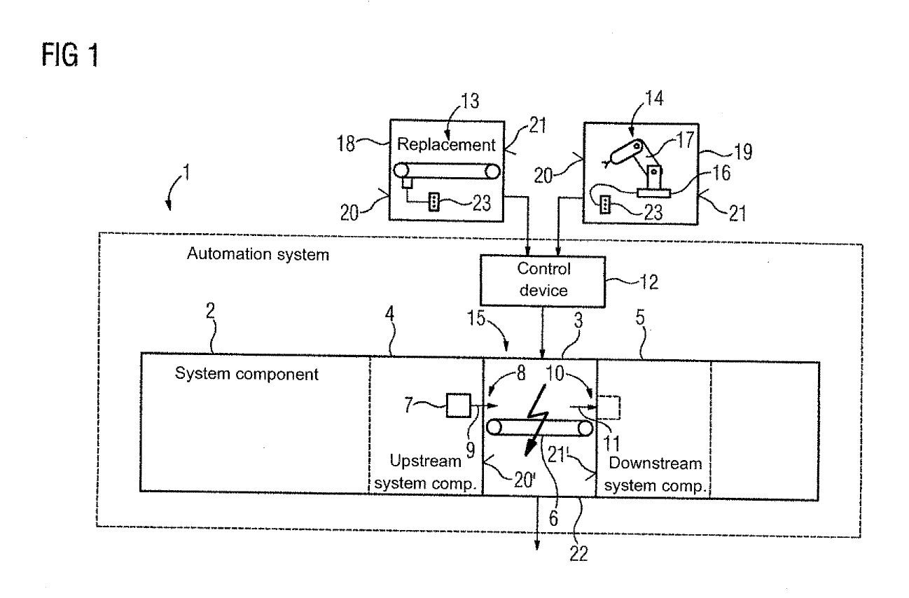

Turning now to the drawing, and in particular to FIG. 1, there is shown an automation system 1 that may be a production system, a process system or a control system. The automation system 1 (or system for short) can have a plurality of system components 2. FIG. 1 shows a faulty system component 3 and also an upstream system component 4 and a downstream system component 5.

By way of example, the faulty system component 3 may have a conveyor belt 6 that receives or accepts from the upstream system component 4 a workpiece or a product 7 at a receiving position 8 at a defined conveying speed 9 and transfers the product 7 at a delivery position or final position 10 to the downstream system component 5, for example at a defined conveying speed 11. The transfer positions 8, 10 and the conveying speeds 9, 11 are operating conditions for operation of the automation system 1.

In the illustrated example, the fault in the faulty system component 3 means that operation of the automation system 1 is no longer possible, e.g. because the system component 3 is at a standstill. The faulty system component 3 needs to be replaced. To this end, the automation system can have a control device 12 that may be designed to determine a suitable substitute component for the faulty system component 3 from a plurality of substitute components 13, 14. The selected substitute component 13, 14 can then be installed at the same installation location 15 between the upstream system component 4 and the downstream system component 5 and is capable of accepting the product 7 at the given conveying speed 9 at the receiving position 8 and of transferring the product 10 to the downstream system component 5 at the final position 10 at the given conveying speed 11. In this case, however, the control device 12 is also able to select, as substitute component 13, 14, a system component that is not designed in the same way as faulty system component 3, in particular the substitute component 13, 14 does not need to have a conveyor belt 6. FIG. 1 shows that although the substitute component 13 can likewise have a conveyor belt, for example, the substitute component 14 may be formed by a robot 16 having a robot arm 17, for example.

To this end, for selection by the control device 12, each substitute component 13, 14 can be represented or described by a component description 18, 19. FIG. 1 shows the respective component description 18, 19 as a black box or model that describes each of the suitable or possible substitute components 13, 14 in terms of their external effect.

Each component description 18, 19 can for example include input conditions 20. The input conditions 20 can indicate at what receiving position 8 a product can be accepted, for example, and at what conveying speed 9 acceptance is possible, for example. Furthermore, each component description 18, 19 can include output conditions 21. The output conditions 21 can for example indicate at what output position 10 and/or at what conveying speed 11 a product can be transferred to a downstream system component 5 by the substitute component 13, 14.

The control device 12 can simply take the component descriptions 18, 19 and a corresponding location description 22 as a basis for checking whether and which substitute component 13, 14 is suitable as a replacement for the faulty system component 3. By way of example, the location description 22 may be formed on the basis of engineering data that define or stipulate or program operation of the system components 3, 4, 5 in the automation system 1. The location description 22 can comprise e.g. the operating conditions described. For the operating location 15, the location description 22 may also provide input conditions 20′ and output conditions 21′ that are intended to be matched by the input conditions and the output conditions of the substitute components 13, 14.

The component descriptions 18, 19 and the location description 22 can also define further constraints, for example a geometry of an installation space or free space available at the operating location 15. Furthermore, at least one connection geometry may be defined, for example. By way of example, at least one electrical interface and/or electronic communication interface may be defined. FIG. 1 shows an electronic interface 23 for transmitting at least one parameter and/or signal by way of example.

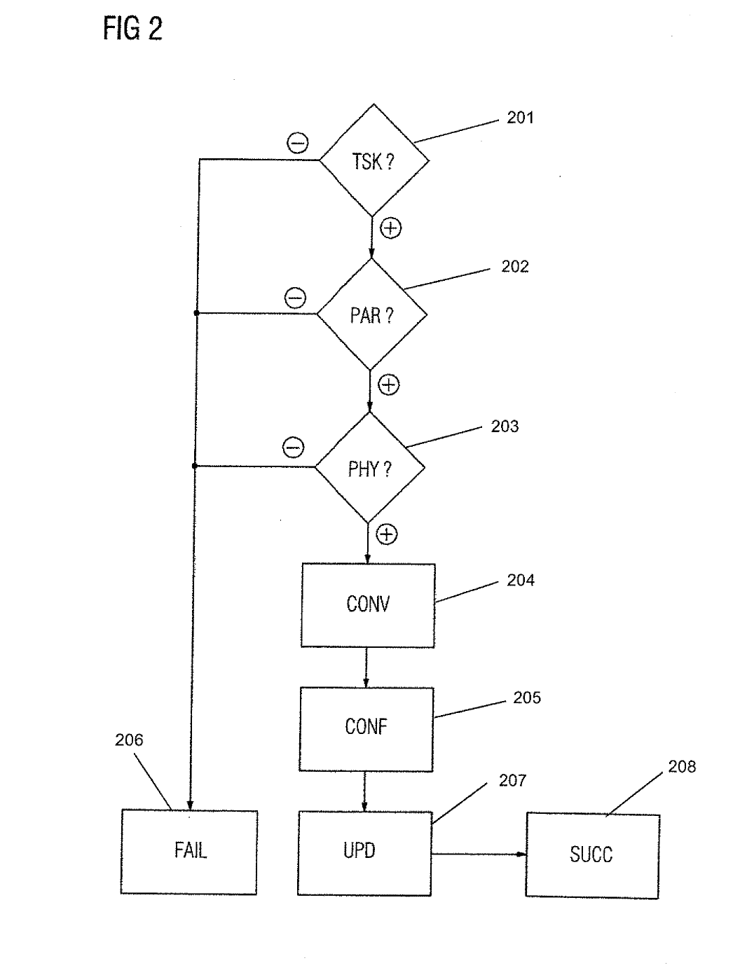

In order to check whether a given substitute component 13, 14 is a suitable replacement for the faulty system component 3, the following method, which is described in connection with FIG. 2, can be carried out by the control device 12.

Defects in a technical component or in a module of a production system (e.g. a conveyor belt or a production machine) require unforeseeable maintenance activities in order for the operating state to be reached again as quickly as possible. If the damaged component cannot be repaired, it needs to be replaced. However, many reasons mean that it is impossible or not worthwhile to replace the damaged component with an identical one: the original component is no longer produced, the identical component is not in stock and/or use of a better component (cheaper, more robust . . . ) is preferred.

When a component is not replaced by an identical one, the issue arises as to which component can be used as a replacement part. Replacements need to be carried out quickly. It is typical not to have to spend time looking for old documents with descriptions of the faulty system component. Therefore, replacement often involves just taking the type plate of a damaged system component as a basis for checking, which in many cases does not provide sufficient information. By way of example, a type plate of an electric motor lists a net power and a maximum current, but no properties such as maximum acceleration.

To be on the safer side, normally a component is selected that provides at least the same power as the component that it is replacing, even if the tasks can be carried out using a less powerful component.

Often, the component configuration or alteration is ignored (alteration, firmware version).

In addition, the automation engineering needs to be altered manually. The hardware configuration needs to be switched and downloaded to the PLC (programmable logic controller) in order to inform the PLC of the new hardware.

Signals from a new component can contain different mathematical units, i.e. signal conversion may be necessary.

Logic circuits (logic functions)/drivers/program libraries may be different, i.e. a new automatic logic circuit then needs to be used.

Hardware interfaces may be different, i.e. a redesign of the communication bus may be necessary.

The documentation for the system needs to be refreshed.

Using the method shown in FIG. 2, the control device 12 succeeds in replacing one technical component with another that is completely different in terms of equipment model or equipment type but that can perform the same main tasks. By way of example, a damaged conveyor belt can be replaced by a robot (a machine) that can execute what are known as pick and place applications. A damaged drill that is replaced by a CNC machine can likewise drill holes.

This is an important step in the direction of flexible industrial production 4.0.

The method assumes that the system had been set up and was running until a system component 3 developed a fault. Up to the time of the fault, an engineering plan had been applied, according to which each component had clearly defined tasks.

The method is based on the concept of ensuring that the tasks of a damaged component are performed by another component without establishing how the task is solved by the substitute component. This is achieved by providing a description (a model) of the component that describes the physical and information-oriented properties of the component and also describes the tasks that can be accomplished by an external starting point (black box). This model is then adapted in accordance with those requirements of the task of the component that have the same functions/properties.

The software model of the component contains the following aspects:

A list of the semantic descriptions of the tasks that the component can perform. The description of each task may be in the form of a static pre-condition and post-condition.

A pre-condition describes the conditions that need to be satisfied before the component can begin its tasks. This also encompasses the prerequisites, such as the state of the component, the initial state of the product, which in turn is influenced by the component, and the state of another component that is connected to the component of interest/that is required.

A post-condition describes the conditions that need to be satisfied after the component has finished its tasks. This again also encompasses the prerequisites, such as the state of the component itself, the final state of the product after the component has finished its tasks, and the state of the other component that is connected to the component of interest/that is required.

The pre-condition or post-condition can be omitted for specific components, such as sensors.

The tasks can provide a semantic description in order to make the definition of the objective simpler, such as “storage” or “transport”.

A semantic description of the interface of the component can be specified as a description of the variables of the component that are able to be influenced or measured. Optionally, physical relevant conditions may be specified for the mechanical features of the component in the system (e.g. maximum component size, flange sizes, connection types). Optionally, further restrictions regarding the use of the component (e.g. maximum energy requirement) may be specified.

The internal dynamic process of the component is not part of the model. By way of example, the model is provided by an external starting point (black box).

The software model of the location of the component, i.e. the location description, contains the same aspects as the model of the component, but describes the task that a component at this position needs to perform.

When the damaged component is replaced by a new one, the control device, e.g. a successor component or a neighboring component (central or local properties), can perform the following steps (see FIG. 2):

At step 201, check match for the task (TSK?): check that at least one of the substitute components contains a task list that can perform the requisite tasks.

If a match has not been found (illustrated by a minus sign “−” in FIG. 2): go to abort (FAIL), at step 206.

If a substitute component has been found (illustrated by a plus sign “+” in FIG. 2): at step 202, check whether the component provides required variables that can be measured or influenced (PAR?).

Optionally: check at step 203, whether the component also has additional requirements, such as physical constraints (PHY?).

If necessary, at step 204, convert the interface values and/or interface signals of the component (CONV=convert) and adapt them to suit the connection interface of the connected components. This can be accomplished by using known methods, such as Plug&Play.

At step 205, refresh the configuration or parameterization of the component involved (CONF=configuration), for example list the requisite task and stipulate the appropriate parameter.

At step 207, refresh technical data for the system, e.g. in the engineering plan (UPD=update).

The method terminates at step 208 by outputting a success report (SUCC=success).

The method shown in FIG. 2 provides a method for checking whether a substitute component meets the requirements for a task that is based on a model according to a black box, e.g. without knowing how the substitute component performs this task, Therefore, the substitute component does not have to resemble the original component, but can manage/perform the tasks in a completely different way.

Such a component can therefore be integrated into an existing production system without manual configuration or adaptation.

The number of replacement parts that need to be kept in stock can be reduced. The result is nevertheless increasing availability of the production systems, since replacement of the component proceeds more quickly and the problem of not having the correct replacement part is reduced.

Further examples illustrate these advantages.

In a first example, the juice in a bottling plant is bottled using a metering valve. Following a malfunction, this can no longer be employed or used. On account of the supply shortage, there are no replacement parts for metering valves in stock.

The company therefore decides to use a measurement pump instead, even though it is costlier than metering and is automated differently.

The graduated tube requires a very specific pressure and density of the received liquid and performs a task by opening the valve for a short time. Input conditions: fill pressure=[2.95 bar to 3.05 bar]; liquid density=[0.99 kg/m³ to 1.01 kg/m³]; output conditions: volume=[at least 0.001 m³]; accuracy=[0.0001 m3]; interface signal: (FUNCTION=“opening value”; TYPE=binary; VALUE_High=0.001 m³/0.01 s; VALUE_Low=0.0 m³/0.01 s).

A pump as a possible substitute component operates regardless of pressure and liquid density: input conditions: fill pressure=[0.1 bar to 10 bar]; liquid density=[0.1 kg/m³ to 3.5 kg/m³]; output condition: volume=[at least 0.001 m³]; accuracy=[0.0001 m³]. Interface signal: (FUNCTION=“volume”; TYPE=integer,' UNIT=mm³/0.001 s).

The location was originally stipulated for the metering valve: input condition: input pressure=[3.0 bar]; liquid density=[1.0 kg/m³]; output condition: volume=[0.02 m³]; accuracy=[0.002 m³].

The comparison result shows that the valve can be replaced by the pump. The input signal changes automatically for the automation project according to the semantic description.

A second example relates to a production system in which a plurality of sequential production steps need to be performed on a metal plate. The metal plate is moved from production center to production center via a production line. An abruptly occurring fault stops the production line, meaning that it takes a few days before the problem is overcome. In order to be able to continue production, the company decides to temporarily replace the conveyor belt with a pick and place machine that is not required elsewhere at the time.

Conveyor belt segment: input condition: PART location=<x>J x=[0 . . . 4.5 m], output condition: PART_location=<x>:x =[0 . . . 4.5 m,' LOCATION_precision=0.1 m]; interface signal: (FUNCTION=“relative position”; TYPE=float,' UNIT=mn1),' (FUNCTION=“start trigger”; TYPE=binary).

The machine (task: Pick&Place): input conditions: PART_location=<x,y,z>: x²+y²+z²<9/m²; LOCATION_precision=0.01 m; output conditions: PART location=<x,y,z>J x²+y²+z²<9 m^{a},' LOCATION_precision=0.01 m; interface signal: (FUNCTION=“start position”; . . . ); (FUNCTION: “end position”; . . . );(FUNCTION=“start trigger”; TYPE=binary).

Location: input condition: PART_location=<0, 0, 0>; output condition: PART_location=<3, 0, 0>.

The result of a comparison is that the conveyor belt segment can be replaced by the machine.

Overall, the example shows how the invention allows system components to be replaced by other, different system components.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for replacing a faulty system component in an automation system, comprising:
with a control device of the automation system:
providing for an operating location of the system component a location description comprising at least one operating condition that needs to be satisfied at the operating location;
providing for at least one possible substitute component a component description comprising operating states that can be assumed by the substitute component and are described independent of a technical design of the substitute component;
determining the component description for which the operating states that can be assumed satisfy each operating condition contained in the location description;
selecting the substitute component associated with the determined component description; and
indicating the selected substitute component for installation at the operating location.

2. The method of claim 1, wherein the at least one operating condition is defined in conjunction with the location description regardless of how the operating condition is satisfied.

3. The method of claim 1, wherein the location description comprises, as the at least one operating condition, at least one input condition which defines at least one state selected from
an operating state of the substitute component required by the automation system at the operating location at the beginning of a process step performed at the operating location,
an initial state of a product to be processed at the operating location, and
an operating state of a system component servicing the operating location.

4. The method of claim 1, wherein the location description comprises, as the at least one operating condition, at least one output condition which defines at least one state selected from
a final state of the substitute component required by the system at the operating location,
a final state of a product to be processed at the operating location, and
an operating state of a system component disposed downstream of the operating location.

5. The method of claim 1, wherein each component description comprises at least one operating environment condition required by the substitute component, and wherein the control device selects the particular substitute component whose at least one operating environment condition is satisfied by the operating location.

6. The method of claim 1, wherein each component description comprises an interface definition for an electronic interface of the substitute component, with the interface definition describing a parameter or a signal format of a signal that is transmitted via the electronic interface, and wherein the control device provides interoperability of a system-side electronic connection interface with the electronic interface.

7. The method of claim 6, wherein the signal transmitted via the electronic interface is converted into a signal from the system-side connection electronic interface and vice versa.

8. The method of claim 1, wherein each component description is provided as a digital model of the substitute component, and wherein the digital model simulates a behavior of the substitute component at a physical interface or at a control interface of the substitute component.

9. The method of claim 1, wherein each component description comprises physical properties of the respective substitute component, and wherein the control device compares the physical properties with corresponding physical situations at the operating location, and wherein the respective substitute component is excluded from the selection when a difference between the physical properties and the corresponding physical situations is detected.

10. The method of claim 9, wherein the physical properties of the respective substitute component comprise at least one of geometrical dimensions, installation space geometries and connection geometries of the respective substitute component.

11. The method of claim 1, wherein each component description lists a resource to be provided by the automation system at the operating location, and wherein the control device excludes the respective substitute component from the selection when the resource is absent.

12. The method of claim 1, wherein the control device is implemented as a central processor of the automation system or as a system component located in close proximity of the operating location.

13. The method of claim 1, wherein the selected substitute component is configured for operation at the operating location based on the location description.

14. The method of claim 1, wherein operation of the automation system is defined by an engineering plan comprising engineering data, wherein engineering data of the faulty system component are replaced in the engineering plan by engineering data of the selected substitute component.

15. A control device for an automation system, comprising a processor configured to replace a faulty system component in an automation system by:
providing for an operating location of the system component a location description comprising at least one operating condition that needs to be satisfied at the operating location;
providing for at least one possible substitute component a component description comprising operating states that can be assumed by the substitute component and are described independent of a technical design of the substitute component;
determining the component description for which the operating states that can be assumed satisfy each operating condition contained in the location description;
selecting the substitute component associated with the determined component description; and
indicating the selected substitute component for installation at the operating location.

16. An automation system comprising at least one control device according to claim 15.
